(19) United States
(12) Patent Application Publication
(10) Pub. No.: US 2018/0245244 A1
(43) Pub. Date: Aug. 30, 2018

(54) PILE FABRIC

(71) Applicant: Kaneka Corporation, Osaka (JP)

(72) Inventors: Takao Michinobu, Hyogo (JP); Wataru Mio, Hyogo (JP); Minoru Kuroda, Osaka (JP)

(73) Assignee: Kaneka Corporation, Osaka (JP)

(21) Appl. No.: 15/966,981

(22) Filed: Apr. 30, 2018

Related U.S. Application Data
(63) Continuation of application No. PCT/JP2016/081861, filed on Oct. 27, 2016.

(30) Foreign Application Priority Data
Oct. 30, 2015 (JP) 2015-215143

(51) Int. Cl. D01F 6/18; D04H 11/08; D04B 1/04; B32B 5/22

(52) U.S. Cl. CPC D01F 6/18; D04H 11/08; D10B 2501/044; B32B 5/22; D04B 1/04

(57) ABSTRACT

A pile fabric includes a plurality of pile portions including a long pile portion and a short pile portion. The short pile portion includes first fibers, and the long pile portion includes second fibers including modified cross-section fibers A. The modified cross-section fibers A have one or more cross-sectional shapes selected from the group consisting of C-shaped cross-sectional shapes and H-shaped cross-sectional shapes, and have a single fiber fineness of 15 to 60 dtex.

### TECHNICAL FIELD

One or more embodiments of the present invention relate to pile fabrics that can be used as artificial furs.

### BACKGROUND

Recently, it has been proposed to refrain from using natural furs for protection of natural environment, and instead use pile fabrics that are made to look like natural furs as artificial furs. Generally, the piloerection portions of natural furs are constituted by fibers whose tips are narrower than the root portions. Natural furs have a two-layered structure of guard hair (also called harsh hair) and down hair (also called downy soft hair). The constitution of the piloerection portions by the fibers whose tips are narrower than the root portions provides natural furs with voluminousness, recovering properties, and soft hand of the front surfaces, which are textures peculiar to natural furs. For the pile fabrics to be used as artificial furs, various techniques have been proposed to configure pile portions to have a two-layered structure to make the pile fabrics resemble the structure of natural furs while imparting, to the pile fabrics, textures resembling natural furs.

For example, Patent Document 1 proposes a pile fabric including fibers having a modified cross-sectional shape and a controlled fineness in a guard hair portion. Patent Document 2 proposes a pile fabric constituted by short piles that are shrinkable fibers with dyed pile portions and long piles that are non-shrinkable fibers having a flat cross section or an oval cross section. Patent Document 3 proposes a pile fabric including fibers having a flat cross-sectional shape in a short pile portion and fibers having a fineness of 0.7 to 8 dtex in a long pile portion, wherein a ratio of the fineness of fibers constituting the long pile portion and the fineness of fibers constituting the short pile portion is set within a specific range.

### PRIOR ART DOCUMENTS

### Patent Documents

Patent Document 1: JP H10(1998)-158959A

Patent Document 2: JP H08(1996)-260289 A

Patent Document 3: WO 2004/009891

However, in the pile fabrics of Patent Documents 1 to 3, the presence of guard hairs is weak visually and tactilely, and an animal hairlike appearance is not sufficiently expressed.

### SUMMARY

One or more embodiments of the present invention provide pile fabrics having an animal hairlike appearance in which the presence of guard hairs is emphasized visually and tactilely.

One or more embodiments of the present invention relate to a pile fabric that includes a long pile portion and a short pile portion. The long pile portion includes modified cross-section fibers A having one or more cross-sectional shapes selected from the group consisting of C-shaped cross-sectional shapes and H-shaped cross-sectional shapes, and having a single fiber fineness of 15 to 60 dtex.

Both of fibers constituting the long pile portion (“second fibers”) and fibers constituting the short pile portion (“first fibers”) may be one or more fibers selected from acrylic fibers and modacrylic fibers. The fibers constituting the short pile portion may have a single fiber fineness of 1 to 15 dtex. The content of the modified cross-section fibers A in a total weight of fibers constituting pile portions may be 5 to 50% by weight.

The long pile portion may have a longer average pile length than the short pile portion by 5 to 60 mm.

One or more embodiments of the present invention provide pile fabrics having an animal hairlike appearance in which the presence of guard hairs is emphasized visually and tactilely.

### BRIEF DESCRIPTION OF THE DRAWINGS

FIG. 1 is a cross-sectional photograph (SEM photograph, 150× magnification) of fibers (having a C-shaped cross-sectional shape) used as guard hairs in Example 1.

FIG. 2 is a cross-sectional photograph (SEM photograph, 350× magnification) of fibers (having a flat cross-sectional shape) used as guard hairs in Comparative Example 1.

FIG. 3 is a cross-sectional photograph (SEM photograph, 150× magnification) of fibers having a six-lobed cross-sectional shape.

FIG. 4 is a cross-sectional photograph (SEM photograph, 150× magnification) of fibers having a Y-shaped cross-sectional shape.

FIG. 5 is a cross-sectional photograph (SEM photograph, 250× magnification) of fibers having a C-shaped cross-sectional shape.

FIG. 6 is a schematic cross-sectional view illustrating C-shaped cross-sectional shapes in modified cross-section fibers A.

FIG. 7 is a schematic cross-sectional view illustrating H-shaped cross-sectional shapes in modified cross-section fibers A.

FIG. 8A and FIG. 8B are schematic cross-sectional views for explaining a method for evaluating the stiffness of fibers.

### DETAILED DESCRIPTION OF THE EMBODIMENTS

The present inventors conducted numerous studies to find a way to visually and sensuously emphasize the presence of fibers constituting a long pile portion (guard hairs) in pile fabrics that include a long pile portion and a short pile portion, so as to impart an animal hairlike appearance to the pile fabrics. As a result, the inventors found that incorporation of modified cross-section fibers A having one or more cross-sectional shapes selected from the group consisting of C-shaped cross-sectional shapes and H-shaped cross-sectional shapes and having a single fiber fineness of 15 to 60 dtex into the long pile portion enables production of pile fabrics having an animal hairlike appearance in which the presence of guard hairs is emphasized visually and tactilely.

In the pile fabric of one or more embodiments of the present invention, a pile portion (“a plurality of pile portions”) includes a long pile portion and a short pile portion having different pile lengths. In one or more embodiments of the present invention, the pile portion refers to a piloerection portion excluding a base fabric (also called a ground structure) portion of the pile fabric. The pile length refers to a length from the root to the tip of the piloerection portion.

The average pile length of the long pile portion may be longer than the average pile length of the short pile portion, by 5 to 60 mm, 5 to 50 mm, or 10 to 45 mm. When the difference in the average pile length between the long pile portion and the short pile portion is within the above-described range, a two-layered structure can be configured that strongly resembles natural furs. In one or more embodiments of the present invention, the average pile length is determined by vertically standing fibers constituting the pile portion of a pile fabric so as to align piles, measuring the lengths from the roots of the fibers constituting the pile portion of the pile fabric (roots on the front surface side of the pile fabric) to the tips of the piles at 10 sections in each pile portion, and averaging the measured lengths.

The average pile length of the long pile portion may be 10 to 120 mm, 10 to 100 mm, or 15 to 100 mm, from the viewpoint of easily obtaining products resembling natural furs (also called real furs). The average pile length of the short pile portion may be 5 to 70 mm, 10 to 50 mm, or 10 to 30 mm, from the viewpoint of easily obtaining products resembling natural furs.

In one or more embodiments of the present invention, when a plurality of pile portions having different pile lengths are present, a pile portion having a longest average pile length is regarded as a long pile portion, whereas a pile portion having a shortest average pile length is regarded as a short pile portion. Here, “pile portions having different pile lengths” means that the average pile lengths of the respective pile portions differ from each other by 5 mm or more. The pile fabric according to one or more embodiments of the present invention may be a pile fabric with three or more levels, e.g., a pile fabric including a medium-length pile portion in addition to the long pile portion and the short pile portion. From the viewpoint of resembling an appearance of natural furs, a pile fabric with two levels composed of a long pile portion and a short pile portion or a pile fabric with three levels composed of a long pile portion, a short pile portion, and a medium pile portion may be possible. In one or more embodiments of the present invention, the fibers constituting the long pile portion are guard hairs, and the fibers constituting the short pile portion and the medium pile portion are down hairs. All of the long pile portion, the medium pile portion, and the short pile portion may be constituted by a single kind of fibers, or two or more kinds of fibers.

In one or more embodiments of the present invention, incorporation of the modified cross-section fibers A into the long pile portion emphasizes the presence of the fibers constituting the long pile portion as guard hairs visually and tactilely. The content of the modified cross-section fibers A in the total weight of the fibers constituting the pile portion may be 5 to 50 wt %, 10 to 45 wt %, or 10 to 35 wt %, from the viewpoint of emphasizing the presence of guard hairs visually and tactilely. Within the above-described range of the content of the modified cross-section fibers A, the presence of the fibers constituting the long pile portion as guard hairs is easily emphasized visually and tactilely; besides, the pile fabric can have a soft and flexible texture. The modified cross-section fibers A may be fibers of a single kind, or fibers of two or more kinds.

The modified cross-section fibers A have one or more cross-sectional shapes selected from the group consisting of C-shaped cross-sectional shapes and H-shaped cross-sectional shapes. The modified cross-section fibers A may have C-shaped cross-sectional shapes from the viewpoint of achieving high stiffness and an excellent presence as guard hairs visually and tactilely.

In the modified cross-section fibers A, the C-shaped cross-sectional shapes include substantially C shapes that are deformed C shapes. FIG. 6 illustrates typical C-shaped cross-sectional shapes. Any shape that has the shape of a letter C or that resembles the shape of a letter C is regarded as a C-shaped cross-sectional shape. A relationship between a length a of an opening and an inner diameter b in FIG. 6 is not limited particularly, but may satisfy a/b≤1, from the viewpoint of emphasizing the presence as guard hairs visually and tactilely and expressing the feeling of standing hairs. As illustrated in FIG. 6, in the C-shaped cross-sectional shape, the length a of the opening is a shortest distance in a part corresponding to the opening of the C shape and the inner diameter b is a length of a line segment that indicates a longest distance in a hollow of the C shape and that is parallel to a line segment indicating the shortest distance.

In the modified cross-section fibers A, the H-shaped cross-sectional shapes include substantially H shapes that are deformed H shapes. FIG. 7 illustrates typical H-shaped cross-sectional shapes. Any shape that has the shape of a letter H or that resembles the shape of a letter H is regarded as an H-shaped cross-sectional shape, and parts corresponding to two vertical lines of H do not need to have a uniform thickness. Apart corresponding to one horizontal line of H does not need to extend from the middles of the two vertical lines or does not need to extend from the same locations, and may be asymmetrical A relationship between a total length (c+d) of the parts corresponding to two vertical lines of H in FIG. 7 and a length e of the part corresponding to one horizontal line of H is not limited particularly, but may satisfy (c+d)/e≥0.5, from the viewpoint of emphasizing the presence as guard hairs visually and tactilely and expressing the feeling of standing hairs. As illustrated in FIG. 7, in the H-shaped cross-sectional shape, the lengths c and d of the vertical lines indicate longest distances in the parts corresponding to two vertical lines in the alphabet H, and the length e of the horizontal line indicates a longest distance in the part corresponding to the horizontal line in the alphabet H.

The modified cross-section fibers A have a single fiber fineness of 15 dtex or more, may have 20 dtex or more, or 25 dtex or more, from the view point of achieving an excellent presence as guard hairs visually and tactilely. The modified cross-section fibers A have a single fiber fineness of 60 dtex or less, may have 55 dtex or less, 53 dtex or less, 51 dtex or less, 45 dtex or less, 40 dtex or less, or 35 dtex or less, from the view point of imparting a soft and flexible texture to a pile fabric.

The long pile portion may be constituted by the modified cross-section fibers A only or may contain other fibers in addition to the modified cross-section fibers A. The cross-sectional shape of the other fibers is not limited particularly, and examples thereof include a circular shape, an oval shape, a flat shape, a Y shape, an X shape, and a multilobed shape. The other fibers may be a single kind, or two or more kinds. The other fibers may have a single fiber fineness of though not limited particularly to, 60 dtex or less, 55 dtex or less, 53 dtex or less, 51 dtex or less, 45 dtex or less, 40 dtex or less, or 35 dtex or less, from the view point of imparting a soft and flexible texture to a pile fabric.

In the long pile portion, the content of the modified cross-section fibers A in the total weight of the fibers constituting the long pile portion may be 20 wt % or more, 25 wt % or more, or 30 wt % or more, from the viewpoint of emphasizing the presence of the fibers constituting the long pile portion as guard hairs visually and tactilely.

The fibers constituting the short pile portion may have a single fiber fineness of though not limited particularly to, 1 to 15 dtex, 1.5 to 13 dtex, or 2 to 12 dtex. When the fibers constituting the short pile portion have a single fiber fineness of 1 dtex or more, the workability in carding and the like improves, and single fibers in a form of a pile fabric are prevented from converging on each other, whereby the quality of the pile fabric improves. When the fibers constituting the short pile portion have a single fiber fineness of 15 dtex or less, a pile fabric as a whole can have a soft texture.

The cross-sectional shape of the fibers constituting the short pile portion is not limited particularly, and examples thereof include a circular shape, an oval shape, a flat shape, a Y shape, an X shape, and a multilobed shape. Among these, an oval shape and/or a flat shape may be possible, from the viewpoint of the voluminousness and recovering properties. The fibers constituting the short pile portion may be a single kind, or two or more kinds.

In one or more embodiments of the present invention, the fibers constituting the pile portion (hereinafter, also referred to as pile fibers) are not limited particularly, and fibers that are generally used for pile fabrics, including acrylic fibers, modacrylic fibers, polyester-based fibers, and vinyl chloride-based fibers, can be used. Both of the fibers constituting the long pile portion and the fibers constituting the short pile portion may be acrylic fibers and/or modacrylic fibers (also called acrylic-based fibers), from the viewpoint of obtaining a flexible texture. In other words, the modified cross-section fibers A may also be acrylic fibers and/or modacrylic fibers. In one or more embodiments of the present invention, the acrylic fibers are fibers made up of a polymer obtained by polymerizing a composition containing acrylonitrile in an amount of 85 wt % or more and other copolymerizable monomers in an amount of 15 wt % or less. The modacrylic fibers are fibers made up of a polymer obtained by polymerizing a composition containing acrylonitrile in an amount of 35 wt % or more and less than 85 wt % and other copolymerizable monomers in an amount of more than 15 wt % and 65 wt % or less.

In one or more embodiments of the present invention, there is no particular limitation on the copolymerizable monomers as long as they can be copolymerized with acrylonitrile. Examples of the copolymerizable monomers include: vinyl halides represented by vinyl chloride and vinyl bromide; vinylidene halides represented by vinylidene chloride and vinylidene bromide; sulfonic acid-containing monomers represented by allylsulfonic acid, methallylsulfonic acid, styrenesulfonic acid, isoprenesulfonic acid, 2-acrylamido-2-methylpropanesulfonic acid, and their metal salts and amine salts; lower alkyl esters of acrylic acid and methacrylic acid, N-alkyl substituted aminoalkyl esters, N,N-alkyl substituted aminoalkyl esters and glycidyl esters; acrylamide, methacrylamide, and their N-alkyl substituted products and N,N-alkyl substituted products; anionic vinyl monomers such as carboxyl group-containing vinyl monomers represented by acrylic acid, methacrylic acid and itaconic acid and their sodium, potassium or ammonium salts; cationic vinyl monomers represented by quaternary aminoalkyl esters of acrylic acid and quaternary aminoalkyl esters of methacrylic acid; vinyl group-containing lower alkyl ethers; vinyl group-containing lower carboxylic acid esters represented by vinyl acetate; and styrene. These monomers may be used alone or in a combination of two or more kinds.

As the copolymerizable monomers, it may be possible to use one or more kinds of monomers selected from the group consisting of vinyl halides, vinylidene halides, and metal salts of sulfonic acid-containing monomers, and it may also be possible to use one or more kinds of monomers selected from the group consisting of vinyl chloride, vinylidene chloride, and sodium styrenesulfonate.

The pile fibers may be modacrylic fibers, or modacrylic fibers obtained by polymerizing a composition containing acrylonitrile in an amount of 35 wt % or more and less than 85 wt %, and vinyl chloride and/or vinylidene chloride and other copolymerizable monomers in a total amount of more than 15 wt % and 65 wt % or less.

In one or more embodiments of the present invention, both of the fibers constituting the long pile portion and the fibers constituting the short pile portion may be non-shrinkable fibers that have been cut into different fiber lengths in advance to express the difference in level in a pile fabric; or the fibers constituting the long pile portion may be non-shrinkable fibers and the fibers constituting the short pile portion may be shrinkable fibers, and the fibers constituting the short pile portion are shrunk in heat treatment during the production of a pile fabric to express the difference in level in the pile fabric. In one or more embodiments of the present invention, the non-shrinkable fibers refer to fibers having a dry heat shrinkage of less than 10%, and the shrinkable fibers refer to fibers having a dry heat shrinkage of 10% or more. The dry heat shrinkage is determined by measuring the lengths of fibers before and after heat treatment under a load of 8.83×10⁻³ cN/dtex and substituting the measured lengths into the following formula. The heat treatment is performed under a dry heat atmosphere of 130° C. for 20 minutes without load.

Dry heat shrinkage (%)=[(Fiber length before heat treatment)−(Fiber length after heat treatment)/Fiber length before heat treatment]×100

An organically-modified silicone-based softener that is at least one selected from the group consisting of amino-modified silicone-based softeners epoxy-modified silicone-based softeners, and carboxyl-modified silicone-based softeners may be adhered to the pile fibers. Such an organically-modified silicone-based softener can improve the flexibility of a pile fabric. The organically-modified silicone-based softener may be an amino-modified silicone-based softener from the viewpoint of more effectively preventing pile fibers from falling off while improving the flexibility of a pile fabric.

When the pile fibers of the pile fabric are acrylic fibers and/or modacrylic fibers, the back surface side of the pile fabric may be subjected to heat sensitive sealing from the viewpoint of preventing fibers from falling off. The pile fibers may have a lower softening point than fibers (ground yarns) constituting the ground structure, from the viewpoint of preventing fusion of pile fibers of the piloerection portion. If the pile fibers includes a plurality of fibers having different softening points, the difference in the softening point between pile fibers having a highest softening point and the fibers constituting the ground structure may be 10° C. or more, 20° C. or more, or 30° C. or more.

When the pile fibers are acrylic fibers and/or modacrylic fibers, the fibers constituting the ground structure may be polyester-based fibers such as polyethylene terephthalate fibers.

An adhesive resin composition may be adhered to the back surface (non-piloerection surface) of the pile fabric by back coating from the viewpoint of making the back surface of the pile fabric more flexible. For example, the adhesive resin composition may be a composition containing one or more adhesive resins selected from the group consisting of styrene-butadiene rubbers (SBR), acrylonitrile-butadiene rubbers (NBR), vinyl acetate-based resins, acrylic ester-based resins, and polyurethane-based resins. Among these, compositions containing one or more acrylic ester-based resins may be used.

### EXAMPLES

Hereinafter, one or more embodiments of the present invention will be described more specifically by way of examples. Note that the present invention is not limited to the examples below.

The stiffnesses of the following modacrylic fibers were measured in the manner described below. Table 1 below shows the results.

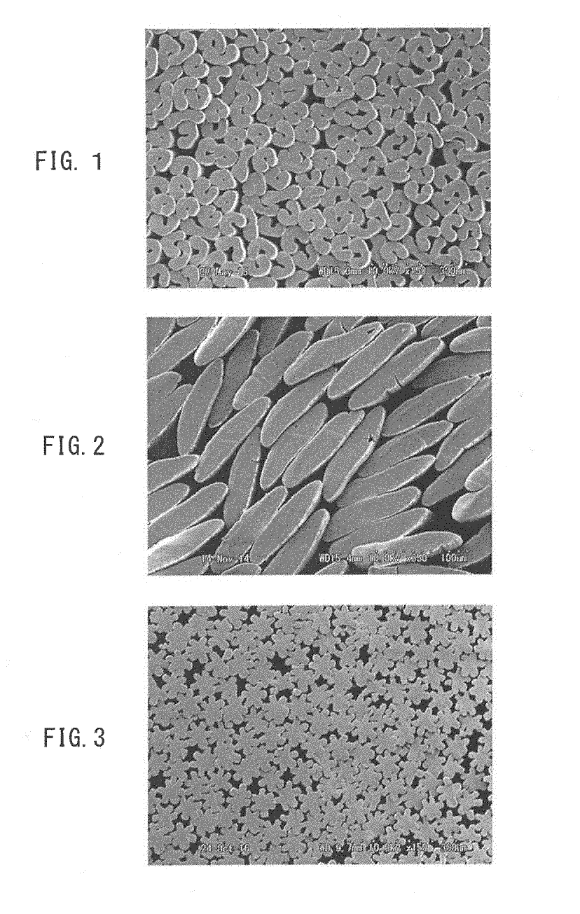

(1) Modacrylic fibers 1: modacrylic fibers (a copolymer composed of 49 wt % of acrylonitrile, 50 wt % of vinyl chloride, and 1 wt % of sodium styrenesulfonate) having a C-shaped cross-sectional shape, a softening point of 180 to 190° C., a single fiber fineness of 27 dtex, and a dry heat shrinkage of 2%; FIG. 1 is a cross-sectional photograph of the modacrylic fibers 1.

(2) Modacrylic fibers 2: modacrylic fibers (a copolymer composed of 49 wt % of acrylonitrile, 50 wt % of vinyl chloride, and 1 wt % of sodium styrenesulfonate) having a flat cross-sectional shape, a softening point of 180 to 190° C., a single fiber fineness of 27 dtex, and a dry heat shrinkage of 2%; FIG. 2 is a cross-sectional photograph of the modacrylic fibers 2.

(3) Modacrylic fibers 3: modacrylic fibers (a copolymer composed of 49 wt % of acrylonitrile, 50 wt % of vinyl chloride, and 1 wt % of sodium styrenesulfonate) having a six-lobed cross-sectional shape, a softening point of 180 to 190° C., a single fiber fineness of 27 dtex, and a dry heat shrinkage of 2%; FIG. 3 is a cross-sectional photograph of the modacrylic fibers 3.

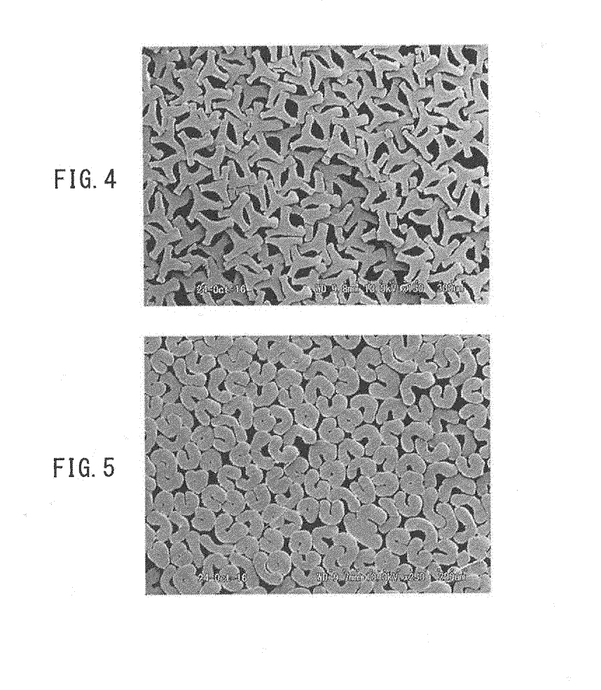

(4) Modacrylic fibers 4: modacrylic fibers (a copolymer composed of 49 wt % of acrylonitrile, 50 wt % of vinyl chloride, and 1 wt % of sodium styrenesulfonate) having a Y-shaped cross-sectional shape, a softening point of 180 to 190° C., a single fiber fineness of 27 dtex, and a dry heat shrinkage of 2%; FIG. 4 is a cross-sectional photograph of the modacrylic fibers 4.

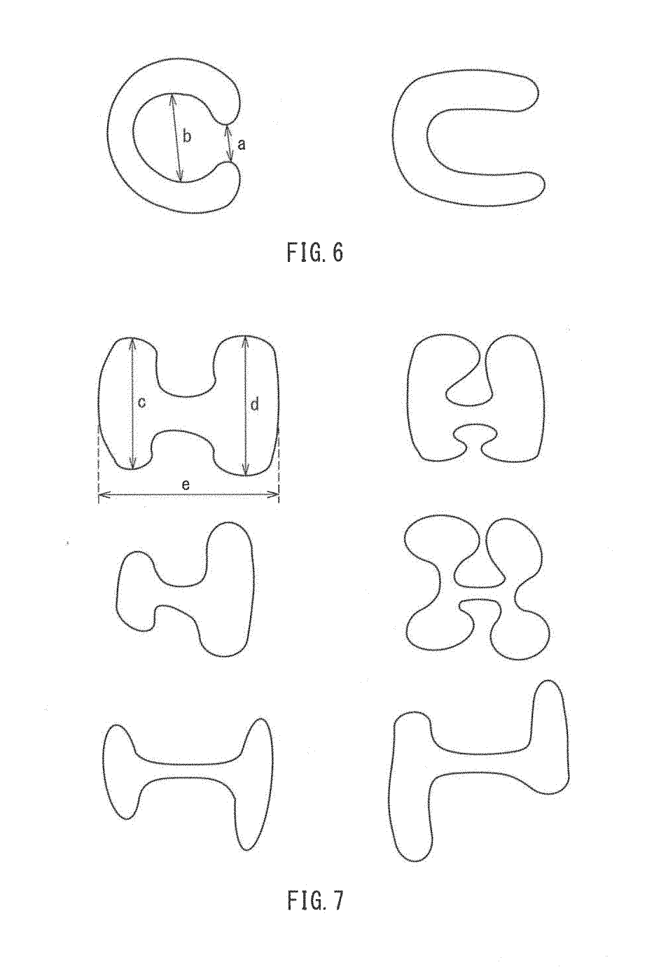

(5) Modacrylic fibers 5: modacrylic fibers (a copolymer composed of 49 wt % of acrylonitrile, 50 wt % of vinyl chloride, and 1 wt % of sodium styrenesulfonate) having a C-shaped cross-sectional shape, a softening point of 180 to 190° C., a single fiber fineness of 10 dtex, and a dry heat shrinkage of 2%; FIG. 5 is a cross-sectional photograph of the modacrylic fibers 5.

(Stiffness of Fibers)

(1) One ends of 20 fibers (non-crimped fibers, cut length: 200 mm) were arranged at regular intervals and fixed with a tape (JOINTEX, trade name “Smart Value, Cloth Tape, Super Economy S”, width 20 mm, length 20 mm) to obtain a fiber bundle (the fiber length of the measuring part: 150 mm). In the fiber bundle, only one ends of the fibers were adhered to the same tape, and the fibers did not overlap with each other.

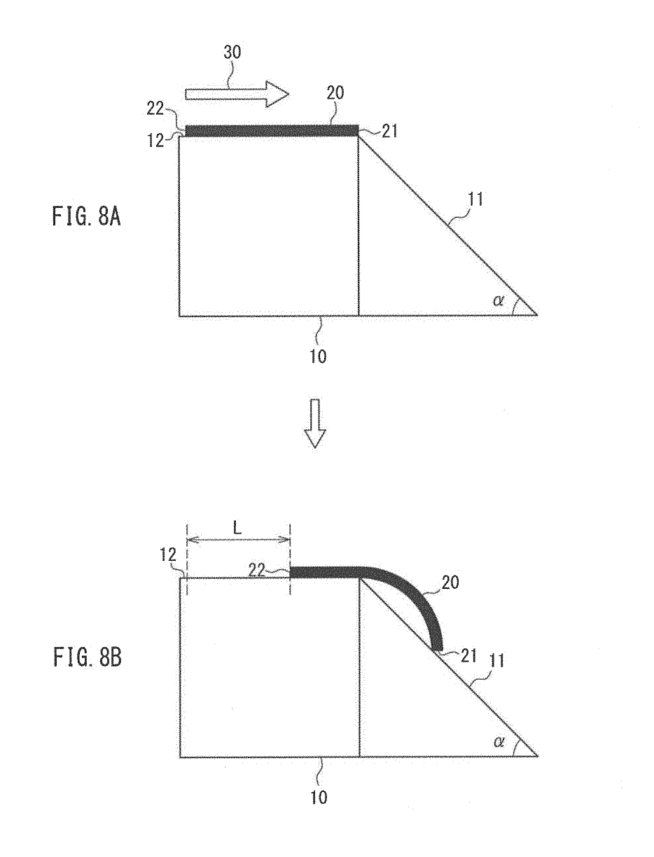

(2) As illustrated in FIG. 8A, a fiber bundle 20 was arranged on a laboratory table 10 made from melamine resin having an inclined surface 11 and a horizontal surface 12 (angle α=45°) (the length of the inclined surface 11: 150 mm, the length of the horizontal surface 12: 200 mm and the width: 100 mm). Next, an end 22 of the fiber bundle 20 adhered to the tape was pushed along a direction indicated by an arrow 30 to gradually slide the fiber bundle 20 out of the horizontal surface 12.

(3) As illustrated in FIG. 8B, the fiber bundle 20 was slid until the other end 21 of the fiber bundle 20 extending out of the horizontal surface 12 curved downward and came into contact with the inclined surface 11.

(4) A distance L of the fiber bundle 20 sliding on the horizontal surface 12 of the laboratory table 10 was measured to determine the stiffness of the fibers. As the value of the stiffness of the fibers increases, the fibers are harder and more excellent in the feeling of standing hairs and the firmness.

TABLE 1

| | Cross-sectional | Single fiber | |
|---|---|---|---|
| Number | shape | fineness (dtex) | Stiffness (mm) |
| Modacrylic fibers 1 | C shape | 27 | 80 |
| Modacrylic fibers 2 | Flat shape | 27 | 45 |
| Modacrylic fibers 3 | Six-lobed shape | 27 | 65 |
| Modacrylic fibers 4 | Y shape | 27 | 70 |
| Modacrylic fibers 5 | C shape | 10 | 40 |

It can be understood from the results of Table 1 above that, when the single fiber finenesses are the same, the modacrylic fibers having a C-shaped cross-sectional shape have higher stiffness than the modacrylic fibers having a flat cross-sectional shape, the modacrylic fibers having a six-lobed cross-sectional shape, and the modacrylic fibers having a Y-shaped cross-sectional shape. Therefore, the presence of the modacrylic fibers having a C-shaped cross-sectional shape is excellent as guard hairs visually and tactilely.

The following are fibers used in examples and comparative examples.

<Fibers>

1. Pile Fibers (Guard Hairs)

(1) Pile fibers 1: The modacrylic fibers 1 were crimped and cut into a length of 60 mm for use. Fibers having a C-shaped cross section of a/b≤1 accounted for 70% in the pile fibers 1.

(2) Pile fibers 2: The modacrylic fibers 1 were crimped and cut into a length of 76 mm for use. Fibers having a C-shaped cross section of a/b≤1 accounted for 70% in the pile fibers 2.

(3) Pile fibers 3: The modacrylic fibers 2 were crimped and cut into a length of 102 mm for use.

(4) Pile fibers 4: The modacrylic fibers 2 were crimped and cut into a length of 76 mm for use.

(5) Pile fibers 5: The modacrylic fibers 5 were crimped and cut into a length of 60 mm for use. Fibers having a C-shaped cross section of a/b≤1 accounted for 60% in the pile fibers 5.

2. Pile Fibers (Down Hairs)

(1) Pile fibers 6: modacrylic fibers (a copolymer composed of 49 wt % of acrylonitrile, 50 wt % of vinyl chloride, and 1 wt % of sodium styrenesulfonate) having a flat cross-sectional shape, a softening point of 180 to 190° C., a single fiber fineness of 5.6 dtex, a dry heat shrinkage of 30%, and a cut length after crimping of 51 mm

(2) Pile fibers 7: modacrylic fibers (a copolymer composed of 49 wt % of acrylonitrile, 50 wt % of vinyl chloride, and 1 wt % of sodium styrenesulfonate) having a bean-shaped cross-sectional shape, a softening point of 180 to 190° C., a single fiber fineness of 4.4 dtex, a dry heat shrinkage of 30%, and a cut length after crimping of 51 mm

“Scanning Electron Microscope S-3500N” manufactured by Hitachi, Ltd. was used to take all the cross-sectional photographs (SEM photographs) of the fibers of FIGS. 1 to 5.

3. Ground Structure Constituent Fibers (Ground Yarns)

A multifilament with a total fineness of 334 dtex (a fiber yarn composed of two filaments arranged in parallel each filament having a fineness of 167 dtex and composed of 50 polyester single fibers) was used. The softening point was 258° C.

The softening point of fibers is a temperature determined in the following manner. 1 g of fibers is opened, placed on a hot plate heated to a predetermined temperature, and pressurized with a pressure roller at 0.07 Kgf/cm² (nip pressure) for three seconds. The temperature at which the surfaces of single fibers in contact with the hot plate are soften and bonded to each other into a plate shape is defined as the softening point of the fibers.

### Example 1

With use of a sliver knitting machine (circular knitting machine) and the above polyester-based fiber yarns as the ground yarns, a pile fabric of Example 1 was knitted by supplying a pile fiber sliver (10 to 14 g) composed of the pile fibers 1 (guard hairs), the pile fibers 6 (down hairs), and the pile fibers 7 (down hairs) that had been mixed uniformly in a mixing ratio of the pile fibers 1/pile fibers 6/pile fibers 7=30/30/40 (parts by weight). The number of loops in the wale of the ground structure was 16 to 17/inch, and the number of loops in the course of the ground structure was 22 to 33/inch. Next the pile fibers on the piloerection surface side of the pile fabric were aligned by polishing and shearing. Specifically first, the pile fibers were polished twice at 120° C., and then sheared twice.

The back surface side of the obtained pile fabric was impregnated with a mixture obtained by mixing a latex of acrylic ester-based resin (“Marpozol M1-K” manufactured by Matsumoto Yushi-Seiyaku Co., Ltd., an emulsified copolymer latex of acrylic ester-based resin, solid concentration: 38.9 wt %) and a latex of acrylic ester-based resin (“TEB-3K” manufactured by Matsumoto Yushi-Seiyaku Co., Ltd., an emulsified copolymer latex of acrylic ester-based resin, solid concentration: 39.1 wt %) in a latex weight ratio (Marpozol M1-K: TEB-3K) of 3:1 so that 15 g/m² of the acrylic ester-based resins (solid content) would be adhered to the back surface. Thereafter, the pile fabric was dried for three minutes using a pin tentor drier at an inner drier temperature of 125° C. while drawing the width to 160 cm, followed by cooling to 80° C. or lower with the width being held at 160 cm. Thereafter the pile fibers on the front surface side of the pile fabric were aligned by polishing, brushing, and shearing. Specifically, first, the pile fibers were brushed twice, polished once at each of 155° C., 150′C, 145° C., 130° C. and 120° C., then sheared twice, and lastly polished twice at 100′C. Consequently a pile fabric with a weight per unit area of 1100 g/m² and a maximum pile fiber length at piloerection portion of 45 mm was obtained.

### Example 2

A pile fabric of Example 2 was produced in the same manner as in Example 1 except that guard hairs were prepared by mixing 10 parts by weight of the pile fibers 2 and 20 parts by weight of the pile fibers 4, instead of using the pile fibers 1.

### Comparative Example 1

A pile fabric of Comparative Example 1 was produced in the same manner as in Example 1 except that the pile fibers 3 were used instead of the pile fibers 1.

### Comparative Example 2

A pile fabric of Comparative Example 2 was produced in the same manner as in Example 1 except that the pile fibers 5 were used instead of the pile fibers 1.

The presence and the feeling of standing of the guard hairs in the pile fabric were evaluated in the manner described below. Table 2 below shows the results. Table 2 also shows the average pile lengths of the respective pile portions measured as described above. All of the pile fabrics of Examples 1-2 and Comparative Examples 1-2 were pile fabrics with two levels composed of the long pile portion and the short pile portion.

<Evaluation Method>

1. Appearance of Pile Fabric: The Presence of Guard Hairs

The presence of the guard hairs in each pile fabric was sensory evaluated by visual observation in terms of visual sense, in accordance with the following criteria.

A: The guard hairs and the down hairs could be visually distinguished, and the presence of the guard hairs was satisfactory.
B: Part of the guard hairs and down hairs could be visually distinguished, and the presence of the guard hairs was acceptable.
C: The guard hairs and the down hairs were visually mixed, and had no presence individually (failure).

2. Touch of Pile Fabric: The Presence of Guard Hairs

The presence of the guard hairs in each pile fabric was sensory evaluated by touch with hand in terms of touch sense, in accordance with the following criteria.

A: The guard hairs could be perceived individually and had a presence.
B: Part of the guard hairs could be perceived individually, and had a presence.
C: The guard hairs were soft, and had no presence individually (failure).

3. Feeling of Standing Hairs

The feeling of standing of the guard hairs in each pile fabric was sensory evaluated in accordance with the following criteria.

A: The standing of the guard hairs from the fabric was perceived after patting the fabric with hand, and the feeling of standing of the guard hairs was satisfactory.
B: The standing of part of the guard hairs from the fabric was perceived after patting the fabric with hand, and the feeling of standing of the guard hairs was acceptable.
C: The guard hairs fell down flat after patting the fabric with hand (failure).

TABLE 2

| | | | Feeling of | Average pile length (mm) | |
|---|---|---|---|---|---|
| | | | standing | Long pile | Short pile |
| | Appearance | Touch | hairs | portion | portion |
| Ex. 1 | A | A | A | 45 | 25 |
| Ex. 2 | B | B | A | 55 | 25 |
| Comp. Ex. 1 | C | C | C | 75 | 25 |
| Comp. Ex. 2 | C | C | C | 45 | 25 |

*Ex.: Example,
Comp. Ex.: Comparative Example

As can be seen from the results of Table 2 above, in the pile fabrics of Examples 1 and 2 using the modified cross-section fibers A having a specific modified cross-sectional shape and having a single fiber fineness of 15 to 60 dtex as the fibers constituting the long pile portion, individual guard hairs had a strong visual and tactile presence, had an animal hairlike appearance, and had satisfactory feeling of standing hairs.

Meanwhile, in Comparative Example 1, since the fibers having a flat cross section were used as the guard hairs of the pile fabric, the finish of the pile fabric as a whole had a very soft texture, but the visual and tactile presence and the feeling of standing of the guard hairs were inferior to those of the guard hairs of Examples 1 and 2. Moreover, in Comparative Example 2 using the fibers having a C-shaped cross-sectional shape and a single fiber fineness of 10 dtex as the guard hairs, the visual and tactile presence and the feeling of standing of the guard hairs were inferior to those of the guard hairs of Examples 1 and 2.

### DESCRIPTION OF REFERENCE NUMERALS

10 laboratory table
11 inclined surface
12 horizontal surface
20 fiber bundle
21, 22 end of fibers (fiber bundle)
30 arrow

Although the disclosure has been described with respect to only a limited number of embodiments, those skilled in the art, having benefit of this disclosure, will appreciate that various other embodiments may be devised without departing from the scope of the present invention. Accordingly the scope of the invention should be limited only by the attached claims.

1. A pile fabric, comprising a plurality of pile portions comprising a long pile portion and a short pile portion,
wherein the short pile portion comprises first fibers,
wherein the long pile portion comprises second fibers comprising modified cross-section fibers A, and
wherein the modified cross-section fibers A have one or more cross-sectional shapes selected from the group consisting of C-shaped cross-sectional shapes and H-shaped cross-sectional shapes, and have a single fiber fineness of 15 to 60 dtex.

2. The pile fabric according to claim 1, wherein both of the first fibers and the second fibers are one or more fibers selected from the group consisting of acrylic fibers and modacrylic fibers.

3. The pile fabric according to claim 1, wherein the first fibers have a single fiber fineness of 1 to 15 dtex.

4. The pile fabric according to claim 1, wherein a content of the modified cross-section fibers A in a total weight of fibers constituting the plurality of pile portions is 5 to 50% by weight.

5. The pile fabric according to claim 1, wherein an average pile length of the long pile portion is 5 to 60 mm longer than an average pile length of the short pile portion.

6. The pile fabric according to claim 2, wherein the first fibers have a single fiber fineness of 1 to 15 dtex.

7. The pile fabric according to claim 2, wherein a content of the modified cross-section fibers A in a total weight of fibers constituting the plurality of pile portions is 5 to 50% by weight.

8. The pile fabric according to claim 3, wherein a content of the modified cross-section fibers A in a total weight of fibers constituting the plurality of pile portions is 5 to 50% by weight.

9. The pile fabric according to claim 6, wherein a content of the modified cross-section fibers A in a total weight of fibers constituting the plurality of pile portions is 5 to 50% by weight.

10. The pile fabric according to claim 2, wherein an average pile length of the long pile portion is 5 to 60 mm longer than an average pile length of the short pile portion.

11. The pile fabric according to claim 3, wherein an average pile length of the long pile portion is 5 to 60 mm longer than an average pile length of the short pile portion.

12. The pile fabric according to claim 4, wherein an average pile length of the long pile portion is 5 to 60 mm longer than an average pile length of the short pile portion.

13. The pile fabric according to claim 6, wherein an average pile length of the long pile portion is 5 to 60 mm longer than an average pile length of the short pile portion.

14. The pile fabric according to claim 7, wherein an average pile length of the long pile portion is 5 to 60 mm longer than an average pile length of the short pile portion.

15. The pile fabric according to claim 8, wherein an average pile length of the long pile portion is 5 to 60 mm longer than an average pile length of the short pile portion.

16. The pile fabric according to claim 9, wherein an average pile length of the long pile portion is 5 to 60 mm longer than an average pile length of the short pile portion.
